(19) United States
(12) Patent Application Publication
(10) Pub. No.: US 2015/0036924 A1
(43) Pub. Date: Feb. 5, 2015

(54) METHOD, ARRANGEMENT AND COMPUTER PROGRAM PRODUCT FOR RECOGNIZING VIDEOED OBJECTS

(71) Applicant: MIRASYS OY, Helsinki (FI)

(72) Inventor: Markus Kuusisto, Helsinki (FI)

(73) Assignee: SENSISTO OY, Espoo (FI)

(21) Appl. No.: 14/385,404

(22) PCT Filed: Mar. 13, 2013
(86) PCT No.: PCT/FI2013/050283

§ 371 Date: Sep. 15, 2014

(30) Foreign Application Priority Data
Mar. 14, 2012 (FI) 20125278

(51) Int. Cl. G06K 9/62; G06T 7/40

(52) U.S. Cl. CPC G06K 9/6201; G06T 7/408
USPC 382/165

(57) ABSTRACT

The pertinence of digital image material is analyzed in respect of matching a given reference. A color of the reference constitutes a reference record in a perceptual color space. Pixels of a piece of digital image material are converted into the perceptual color space, and labelled according to how their converted pixel values belong to environments of principal colors in the perceptual color space. A connected set of pixels is selected that have at least one common label. A subset of the connected set of pixels is determined, so that the pixel(s) of the subset are those for which a color similarity distance to the reference record is at an extremity. For the connected set of pixels, a representative color is selected among or derived from the color or colors of the pixels that belong to the subset.

### TECHNICAL FIELD

The invention concerns in general the technology of evaluating digital images on the basis of their content. Especially the invention concerns the technology of arranging digital images into an order according to how good a match is found in each image to a given reference.

### TECHNICAL BACKGROUND

Recognizing objects from digital images is relatively easy for a human observer, but has proven difficult to perform effectively and reliably with programmable automatic devices. As an example we may consider a fictitious task of watching footage coming from a surveillance camera. If a human observer is told to keep watch for a person carrying a bag of a given color, he or she can probably identify with relative ease the correct video sequence where the person in question walks by. An algorithm not only has difficulty in correctly recognizing the color (because lighting and other factors may affect its appearance in the image), but it also lacks the cognitive capability of correctly interpreting the contents of the images with reference to terms like “person”, “carry”, and “bag”.

However, the large amount of digital footage produced by an imaging arrangement and its duration over long, possibly uninterrupted periods of time quickly make it impractical to have a human observer evaluate all material, especially because the same material may need to be evaluated in respect of a large number of criteria. An automated detection system may work slowly in a case where a reference color (matches to which are to be found) is given later, because then the system must go through possibly a very large number of video frames, looking for best matches to the newly given color.

### SUMMARY OF THE INVENTION

An objective of the invention is to provide a method, an arrangement and a computer program product that enable arranging digital images and/or image sequences in an order of pertinence in respect of matching a given reference.

Another objective of the invention is to make such arranging effectively and reliably. Yet another objective of the invention is to ensure that such arranging, when performed automatically by a programmed apparatus, gives results that meet the subjective human perception of pertinence.

Objectives of the invention are achieved by considering colors and color similarity distances in a perceptual color space, performing coarse classification of pixels by labelling, and for a selected set of pixels, utilizing as its representative color a color that is defined by those of its pixels that are closest to a reference color. For selected sets of pixels, colors that are representative with respect to a set of principal colors or otherwise defined parts of the color space can be calculated beforehand and stored, in order to make it faster to compare the matches of such selected sets of pixels to later given, arbitrary reference colors.

A method according to the invention is characterised by the features recited in the characterising part of the independent claim directed to a method.

The invention concerns also an arrangement that is characterised by the features recited in the characterising part of the independent claim directed to an arrangement.

Additionally the invention concerns a computer program product that is characterised by the features recited in the characterising part of the independent claim directed to a computer program product.

The novel features which are considered as characteristic of the invention are set forth in particular in the appended claims. The invention itself, however, both as to its construction and its method of operation, together with additional objects and advantages thereof, will be best understood from the following description of specific embodiments when read in connection with the accompanying drawings.

The exemplary embodiments of the invention presented in this patent application are not to be interpreted to pose limitations to the applicability of the appended claims. The verb “to comprise” is used in this patent application as an open limitation that does not exclude the existence of also unrecited features. The features recited in depending claims are mutually freely combinable unless otherwise explicitly stated.

### BRIEF DESCRIPTION OF DRAWINGS

FIG. 1 illustrates a piece of digital image material,

FIG. 2 illustrates the HCL color space,

FIG. 3 illustrates a detail of the piece of digital image material of FIG. 1,

FIG. 4 illustrates a sequence of images,

FIG. 5 illustrates four sequences of images,

FIG. 6 illustrates a method and a computer program product,

FIG. 7 illustrates the use of preprocessed digital image material, and

FIG. 8 illustrates an arrangement.

### DETAILED DESCRIPTION OF EMBODIMENTS OF THE INVENTION

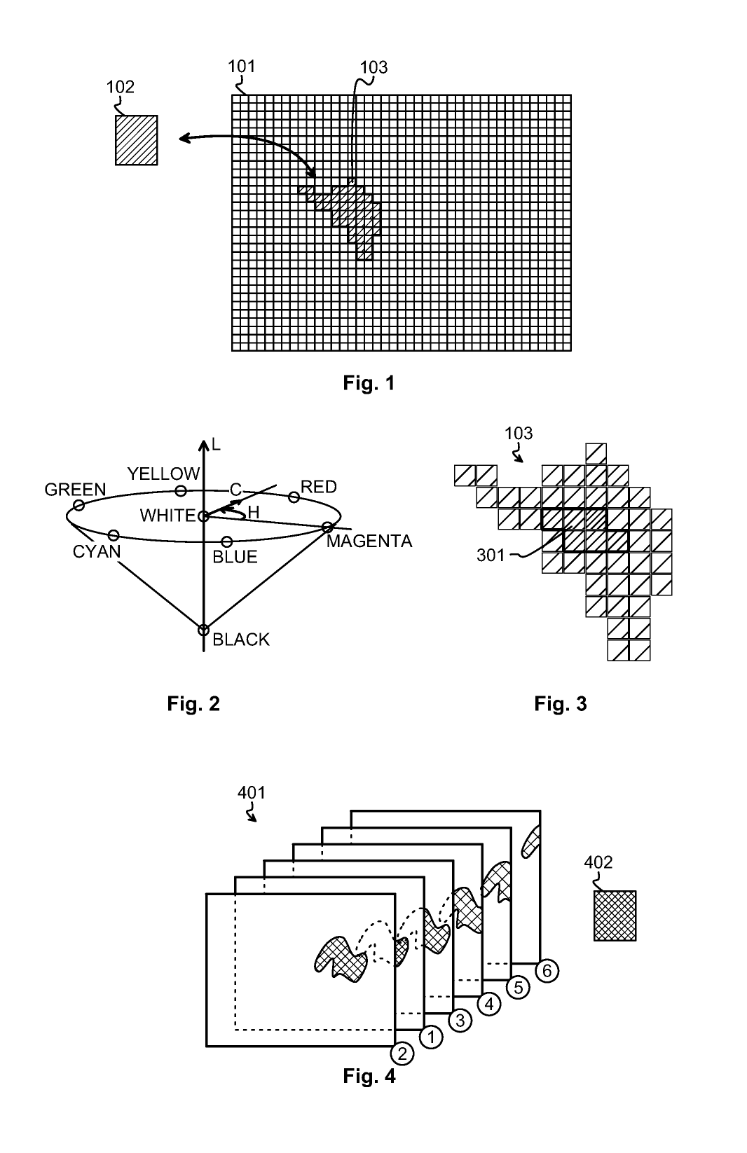

FIG. 1 illustrates schematically a situation where the pertinence of a piece 101 of digital image material should be analysed in respect of matching a given reference 102. In particular, the piece of digital image material should be evaluated in terms of whether it contains images of any objects that would have the same color as the reference 102.

The rapid development of digital imaging has made evaluations like that described above much more complicated than before. A digital image routinely comprises millions of pixels, and each individual pixel may have a color selected among millions of possible colors. The extremely fine color scale, where only very small discrete steps exist between different shades of color, means that in practice an image taken of a natural subject with a digital camera very seldom contains any extended areas of exactly same color. Even if it did, the probability of that color being exactly the same as a given reference color is very small. Thus, in order to evaluate, how close a digital image is to containing an image of an object of the given color, one must find answers to questions like: which pixels in the image should be considered to belong together so that they constitute a connected set; which color should be taken as a “representative” color of the connected set, so that one could say that said object appears as having predominantly that color in the image; and how closely does said “representative” color of the connected set match the given reference color. If a quantitative answer exists to the last-mentioned question, the relative pertinence of a number of digital images can be analysed, and digital images can be arranged into an order of pertinence in respect of a given reference color.

If the reference 102 is known at the time when the piece 101 of digital image material is obtained, it may be possible to perform the evaluation simultaneously or essentially simultaneously. However, in many cases for example video footage exists that covers long periods of time, and only later there is given a particular reference color, matches to which should be found among the large numbers of frames that constitute said video footage.

### Color Spaces

The most common color space used to express pixel values of a digital image is the so-called RGB space, in which the letters come from Red, Green, and Blue. The pixel value is a triplet of parameters {R, G, B} in which each individual parameter has a value from 0 to 255, the ends included. However, it has been found that the distance between two points in the RGB space is not a very good measure of a color similarity distance as understood by the human brain. In other words, even if two points appear relatively close to each other in the RGB space, a human observer would not necessarily perceive the corresponding two colors as being very similar to each other.

A color space that enables intuitively associating the way in which colors are represented with the way in which colors are understood by the human brain is called a perceptual color space. Known and widely used perceptual color spaces include but are not limited to the following:
YUV, where each color has a luma (Y) and two chrominance (UV) components,
HSV or HSB, where each color has a hue (H), saturation (S), and value (V) or brightness (B) component, and
HSL or HSI, where each color has a hue (H), saturation (S), and lightness (L) or intensity (I) component.

Conversion formulae exist and are well known for converting the representations of colors between different color spaces.

A scientific paper M. Sarifuddin, Rokia Missaoui: “A New Perceptually Uniform Color Space with Associated Color Similarity Measure for Content-Based Image and Video Retrieval”, Proceedings of Multimedia Information Retrieval Workshop, 28th annual ACM SIGIR Conference, pp. 1-8, 2005, introduces another perceptual color space, which has many advantageous features in respect of embodiments of the present invention. In a HCL space, each color has a hue (H), chroma (C), and luminance (L) component. The C and L values of a color are related to the R, G, and B values of the same color in RGB space through

$$L = \frac{Q \cdot max ( R , G , B ) + ( 1 - Q ) \cdot min ( R , G , B )}{{Y}_{1}}$$

$$C = \frac{Q \cdot ( \vert R - G \vert + \vert G - B \vert + \vert B - R \vert )}{{Y}_{2}}$$

where Q=e^{αγ},

$$α = \frac{min ( R , G , B )}{max ( R , G , B )} \cdot \frac{1}{{Y}_{0}} ,$$

and

Y₀, Y₁, Y₂, and γ are constants.

Typical values of said constants are Y₀=100, Y₁=2, Y₂=3, and γ=3, but other values can be selected in order to tune the representation of colors in the HCL space according to need.

The H value of a color in a HCL space is related to the R, G, and B values of the same color in RGB space through one of

$$\{ \begin{matrix}[ ( R - G ) \geq 0 ⋀ ( G - B ) \geq 0 ] ⇒ H = {H}^{′} \\ [ ( R - G ) \geq 0 ⋀ ( G - B ) < 0 ] ⇒ H = {H}^{′} \\ [ ( R - G ) < 0 ⋀ ( G - B ) \geq 0 ] ⇒ H = 180 + {H}^{′} \\ [ ( R - G ) < 0 ⋀ ( G - B ) < 0 ] ⇒ H = {H}^{′} - 180\end{matrix} \\ or \\ \{ \begin{matrix}[ ( R - G ) \geq 0 ⋀ ( G - B ) \geq 0 ] ⇒ H = \frac{2}{3} {H}^{′} \\ [ ( R - G ) \geq 0 ⋀ ( G - B ) < 0 ] ⇒ H = \frac{4}{3} {H}^{′} \\ [ ( R - G ) < 0 ⋀ ( G - B ) \geq 0 ] ⇒ H = 180 + \frac{4}{3} {H}^{′} \\ [ ( R - G ) < 0 ⋀ ( G - B ) < 0 ] ⇒ H = \frac{2}{3} {H}^{′} - 180\end{matrix} \\ where {H}^{′} = {tan}^{- 1} \frac{G - B}{R - G} .$$

A color similarity distance between two HCL value sets H₁C₁L₁ and H₂C₂L₂ is calculated as

$$\{ \begin{matrix}[ ( R - G ) \geq 0 ⋀ ( G - B ) \geq 0 ] ⇒ H = {H}^{′} \\ [ ( R - G ) \geq 0 ⋀ ( G - B ) < 0 ] ⇒ H = {H}^{′} \\ [ ( R - G ) < 0 ⋀ ( G - B ) \geq 0 ] ⇒ H = 180 + {H}^{′} \\ [ ( R - G ) < 0 ⋀ ( G - B ) < 0 ] ⇒ H = {H}^{′} - 180\end{matrix} \\ or \\ \{ \begin{matrix}[ ( R - G ) \geq 0 ⋀ ( G - B ) \geq 0 ] ⇒ H = \frac{2}{3} {H}^{′} \\ [ ( R - G ) \geq 0 ⋀ ( G - B ) < 0 ] ⇒ H = \frac{4}{3} {H}^{′} \\ [ ( R - G ) < 0 ⋀ ( G - B ) \geq 0 ] ⇒ H = 180 + \frac{4}{3} {H}^{′} \\ [ ( R - G ) < 0 ⋀ ( G - B ) < 0 ] ⇒ H = \frac{2}{3} {H}^{′} - 180\end{matrix} \\ where {H}^{′} = {tan}^{- 1} \frac{G - B}{R - G} ;$$

where A_{L} and A_{H} are constants. Typical values of said constants are A_{L}=1.4456 and A_{H}=1, but other values can be selected in order to tune the representation of colors in the HCL space according to need. Taking the square root can be left out of the calculation of the color similarity distance, because its presence is only motivated by geometrical considerations that are based on perceiving the HCL color space as occupying a conical region of space, and because leaving it out would not affect the mutual order of magnitude of the calculated color similarity distances.

### Color of a Reference in a Color Space

According to an aspect of the invention, if similarity to a given reference should be evaluated, it is advantageous to express a color of said reference as a reference record in a perceptual color space. The reference record may mean a point in the perceptual color space, in which case the reference has a unique, unambiguously defined single color; for example in a HCL color space the reference such a reference has a unique set of the H, C, and L component values. As an alternative, the reference record may mean a region in the perceptual color space, so that said region encloses a number of points and consequently represents a number of colors in said perceptual color space. In order to maintain an unambiguous definition for the concept of color similarity distance, it is advantageous (but not necessary) that the region has a relatively simple, convex form. Assuming that the perceptual color space is defined with three coordinates, the region may be one-, two- or three-dimensional.

A special case of particular importance is the definition of a reference record as the set of points that maximises or minimises a component value in the color space. For example, as was mentioned above, the HCL color space can be thought of as a conical region of space as illustrated in FIG. 2. The L (luminance) component increases upwards in FIG. 2, the H (hue) component indicates the rotation angle around the vertical axis, and the C (chroma) component indicates the horizontal distance from the vertical axis. The pure principal colors (red, yellow, green, cyan, blue, and magenta) are located at regular intervals along the largest circumferential rim of the conical region, while black is at the sharp point of the cone and white is at the middle of its circular bottom (which is upwards in FIG. 2).

Maximising a component value in a color space like that of FIG. 2 means looking for points that are as high up as possible in the color space (if maximising the L component was aimed at), as far from the vertical axis as possible (if maximising the C component was aimed at), or at a maximum rotation angle around the vertical axis (if maximising the H component was aimed at). Minimising a component value means the opposite: looking for points that are as low as possible, as close to the vertical axis as possible, or at a minimum rotation angle around the vertical axis. As an illustrative example, if only the circular bottom surface of the conical region of FIG. 2 was considered, maximising the C component would be equal to defining the whole largest circumferential rim, along which the pure principal colors are located, as the reference record.

According to another aspect of the invention, the points that represent the principal colors of a color space may be used as default references. Using one or more default references is particularly advantageous in a case where digital image material is obtained and stored for the purpose of later evaluating matches to an arbitrary color.

Identifying Pixels that Represent an Object

Throughout this description, an “object” is considered to exist in real world: a human, a bag, a car, and a cloud are all examples of objects. A twodimensional digital image comprises picture elements or pixels (correspondingly a three-dimensional image comprises volume elements or voxels), so that if an object is visible in a digital image, we say that it is “represented” by a set of pixels or voxels in the image. Saying that the object “appears” in a piece of digital image material means the same, i.e. that the piece of digital image material comprises a set of pixels that represent the object. What is said about pixels in this description can be directly generalised to voxels, if three-dimensional image information is considered.

According to an aspect of the invention, the mere number of individual pixels that happen to be close to a reference by color is not that interesting, if such pixels are just sporadically distributed here and there in digital image material. For most applications, it is objects or parts of objects of (at least) particular size that are of interest, so that a piece of digital image material should be evaluated in terms of whether it contains a representation of an object (or part of object) or how well does the representation contained therein match a given reference. In digital image processing and also more generally in mathematics, the concept of connectedness is used to describe, whether a certain entity can be considered to consist of one piece. It is customary to speak about running a “connect routine” or a “connected component analysis” on a digital image in order to identify sets of pixels that are “connected”, i.e. that belong together and thus constitute an entity called a connected component or a connected set of pixels. Such a connected set often represents a particular object or part of object in the image. Prior art publications that consider aspects of connectedness in a digital image are for example US2010066761, US2006132482, US2003083567, and WO0139124.

A method according to an embodiment of the invention comprises selecting from a piece of digital image material a connected set of pixels. In FIG. 1 an example of such a connected set of pixels is illustrated as the set 103 of pixels that have the same kind of hatch (marking a roughly similar color) as the reference 102.

### Selecting the Representative Color

Above it was pointed out that an area singled out from a digital image, even if selected as a connected set of pixels, very seldom comprises pixels of exactly the same color. FIG. 3 illustrates schematically a close-up of the set 103 of pixels that was selected as a connected set of pixels in the digital image that constitutes the piece 101 of digital image material in FIG. 1. The different density of the hatches of the pixels illustrates their different colors. Since a color similarity distance in a color space is defined only as the distance between individual points (i.e. individual, unambiguously determined colors), there remains the problem of which of the multitude of different colors contained in the set 103 of pixels should be selected as the “representative” color of that set. A representative color is that color, for which the distance to the reference color will be calculated. Thus the selection of a representative color will ultimately determine, how close to the reference color the set 103 of pixels as a whole will be considered to be.

A relatively straightforward alternative would be to calculate some kind of a mean value of all pixel values in the set 103, and use that mean value as the representative color. However, it has proven more advantageous to determine a subset of the connected set of pixels, so that the pixel or pixels of said subset are those for which a color similarity distance to said reference is smallest among said connected set of pixels. The representative color is picked among or derived from the color(s) of the pixel(s) of the subset. The subset comprises at least one pixel.

In other words, when looking for a representative color for the set 103, one goes looking for that or those of its pixels that as such are closest to the reference in color. According to one embodiment, the subset consists of a single pixel, which is the one, the color of which best matches the color of the reference. In such a case one thus considers the whole connected set of pixels to match the reference as accurately as its best matching pixel does. In some cases it is more practical to define a kind of “inverse reference”, so that the pixel or pixels of said subset are those for which a color similarity distance to said reference is largest among said connected set of pixels. In general, we may say that the pixel or pixels of said subset are those for which a color similarity distance to said reference is at an extremity among said connected set of pixels.

According to another embodiment, the subset consists of a small number of best-matching (or, in case of an “inverse reference”, worst-matching) pixels, like less than 50, or less than 30, or even 10 pixels or less in a decreasing order of matching the reference color. FIG. 3 illustrates determining a subset 301 of six (6) pixels. In order to have the concept of a subset to have significance, and also in order to emphasize looking for the representative color among the best-matching pixels, an indicative upper limit for the size of the subset may be considered, like at most a third, at most a half, or at most two thirds of the connected set of pixels. Not relying only on the single best-matching pixel decreases the risk that a single imaging or storing error, an individual jamming pixel in a detection device, or some other exceptional, erroneous condition could cause a much larger set of pixels to be evaluated erroneously.

When the subset has been determined, one may e.g. select the color of a random pixel within the subset as the representative color, or calculate a mean or medial value or some other statistical descriptor value of the colors of all pixels in the subset. Yet another alternative is to determine a relatively small subset, like 5 best-matching pixels in a decreasing order of matching, and to always select the color of the last pixel in the subset as the representative color.

Another possible way of selecting the representative color is to calculate a weighted average color of all pixels in the subset, or a weighted average of even all pixels in the connected set of pixels. In calculating the weighted average, each color is given a weight that emphasizes that color the more, the smaller is the distance between it and the reference. Mathematically this can be accomplished for example by weighting each color with an inverse of its distance to the reference, raised to a suitable power. The larger the exponent of the inverse distance, the more the weighting emphasizes the colors closest to the reference in calculating the weighted average.

### Using Representative Color to Obtain Pertinence Value

After the representative color has been selected among or derived from the colors of the pixels in the subset and stored, we may calculate the color similarity distance between the representative color and the given reference color. That can be then said to constitute a color similarity distance between said subset and said reference. The smaller the color similarity distance, the better the whole set of pixels (from which the subset was determined) matches the reference.

If, at this point, the reference was only a default reference (like one of the principal colors of the color space) and the selection of a representative color was made to enable faster evaluation of matches to an arbitrary, “true” reference that will be given later, it is not necessary to calculate and store the color similarity distance. It suffices to store, with respect to the particular connected set of pixels, its selected representative color.

If the aim was to find a piece of digital image material that matches a given reference as closely as possible, the above-mentioned color similarity distance can then be directly used to describe the pertinence of the whole piece of digital image material. If the color similarity distance is not used as such, some kind of an unambiguous mapping and/or filtering function can be used to calculate and store a pertinence value that is representative of the color similarity distance between said subset and said reference.

### Example

### Evaluating Images of a Sequence

FIG. 4 illustrates schematically a case in which the task is to analyse a piece of video footage 401 in order to identify the frame in which the best match is found to a given reference color 402. The fact that a single best-matching frame is looked for means that the piece of digital image material, the pertinence of which in respect of matching the given reference is analysed, is a single digital image (i.e. each individual frame in turn). The individual digital images are just extracted from a series or sequence of digital images.

It is naturally possible to run a connect routine on each individual frame separately in order to identify connected sets of pixels. However, in the case illustrated in FIG. 4 we additionally assume that the video footage comes from a fixedly installed or otherwise relatively stationary camera, and that only objects that move in relation to the camera are of interest. Features of the background, which are stationary in relation to the camera and which consequently appear in the same way in all frames, need not be analysed. Consequently, in this embodiment the method comprises using motion detection within the sequence of digital images in selecting areas where connected sets of pixels will be looked for, so that they represent an object or part of an object that appears non-stationary in the sequence of digital images. Motion detection is known as such and involves making comparisons between consecutive images, and/or between what is known about the stationary background and what is found different in a particular frame.

If we assume that the sequence in FIG. 4 is arranged with its oldest image at the bottom, we note that a moving object has entered the field of view from the right-hand side and moved so that it appears differently in each frame. Even if it is the same object all the time, differences in ambient lighting and/or other conditions may cause its coloring to slightly differ in different frames. This is illustrated in FIG. 4 by slightly varying the intensity of the cross hatch. When the appropriate connected sets of pixels are selected and for each of them the appropriate subset is determined, the representative color for the connected set is stored, and pertinence value calculated, one may find an order of pertinence of the individual frames as illustrated by the encircled numbers at their lower right corners. The second newest frame is found most pertinent, which means that the color similarity distance between the subset of pixels determined from its connected sets of pixels and the reference 402 is found the smallest. In that frame we will thus find the appearance of the moving object or part of object that most accurately matches the reference.

### Example

### Evaluating Sequences of Images

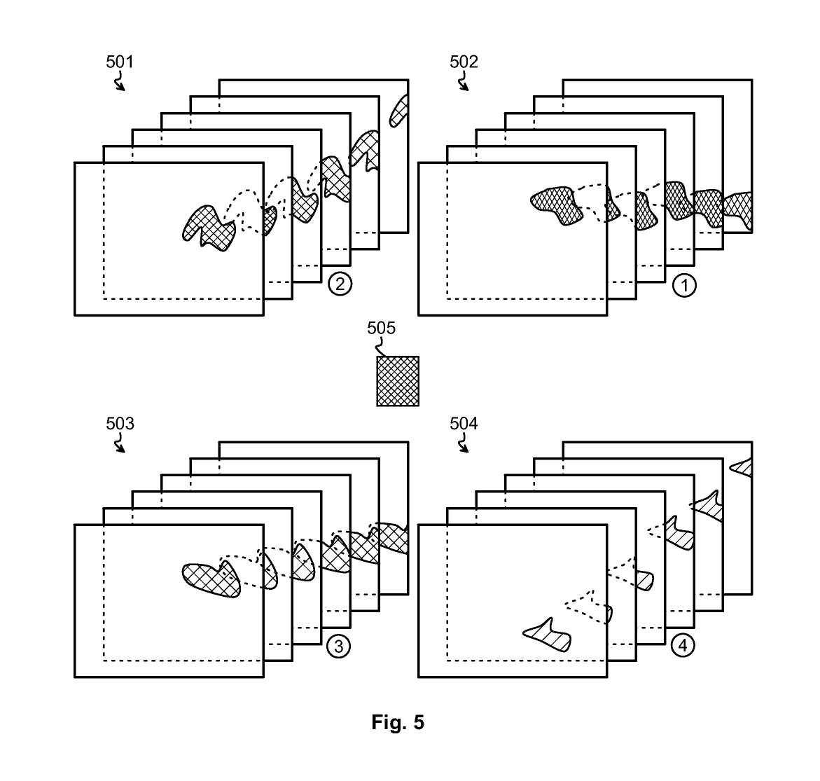

In FIG. 4 the question was, which individual image taken from a sequence of images contained the most accurate match to a reference. Embodiments of the invention can be applied also to evaluating, which video sequence—among a number of candidate sequences—contains the most accurate match. FIG. 5 illustrates schematically an exemplary case in which there are four candidate sequences 501, 502, 503, and 504. One should select the sequence, in which the most accurate match is found with a reference 505. Using the “piece of digital image material” notation, in this case we may say that the piece of digital image material comprises a sequence of digital images.

Comparing video sequences to each other may proceed by calculating and storing pertinence values separately for a number of individual digital images of each sequence, and calculating and storing a pertinence value for the sequence as a function of the pertinence values of the individual digital images. Said function may be for example one of the following:
select the (N) best: the pertinence of the video sequence is as good as the pertinence of the most pertinent frame contained in that sequence, or the combined pertinence of the N most pertinent frames, where N is an integer
calculate mean or median: in order to get the pertinence of the video sequence, one first calculates the pertinence values of its individual frames and then takes a median or mean value of those.

In FIG. 5 it is assumed that the sequence on the top right comprises the best match to the reference 505, followed by the top left, bottom left, and bottom right sequences in this order.

Concerning video sequences, it is also possible to express limits for targeted appearance of objects or parts of object in images of a sequence, and only select a connected set of pixels as a response to finding that an object or part of object represented by such pixels makes an appearance that is within said limits in the sequence under examination. In other words, by expressing said limits, one may preliminarily aim the search of the most pertinent sequence to those where the object or part of object appears in a particular way. In the beginning of this description, an example was mentioned in which one should find a sequence where a person carries a bag of a particular color. In such a case, at least some of the following could be expressed as limits:
the object or part of object appears to move in a direction that is horizontal, or otherwise natural for a carried object (i.e. there is a target direction in which an object or part of object appears to move in images of said sequence)
the movement of the object or part of object appears to follow a particular trajectory, i.e. a series of consecutive directions of movement (i.e. there is a target trajectory along which an object or part of object appears to move in images of said sequence).

It should be noted that motion detection as such is only a method for detecting pixels that represent moving objects or parts of objects. If criteria of the kind mentioned above are to be applied, object tracking is required. An advantageous method for object tracking has been described in a co-pending patent application number 20125276, “A method, an apparatus and a computer program for predicting a position of an object in an image of a sequence of images”, which is assigned to the same assignee and incorporated herein by reference.

Further types of limits, which can be also applied to the evaluation of individual images, are for example the following:
the object or part of object represented by the connected set of pixels appears to have a size that fits predefined limits (in the mentioned example, the object or part of object appears to have a size that would be natural for a bag)
the object or part of object represented by said connected set of pixels appears to have a shape that meets a predefined reference shape at a predefined accuracy (e.g. the shape of a bag)
the object or part of object represented by said connected set of pixels appears to have a predefined spatial relation to another object or part of object (for example, the object assumed to be a bag is adjacent to a larger object in the image that could be a person carrying the bag).

### Exemplary Embodiment of a Method

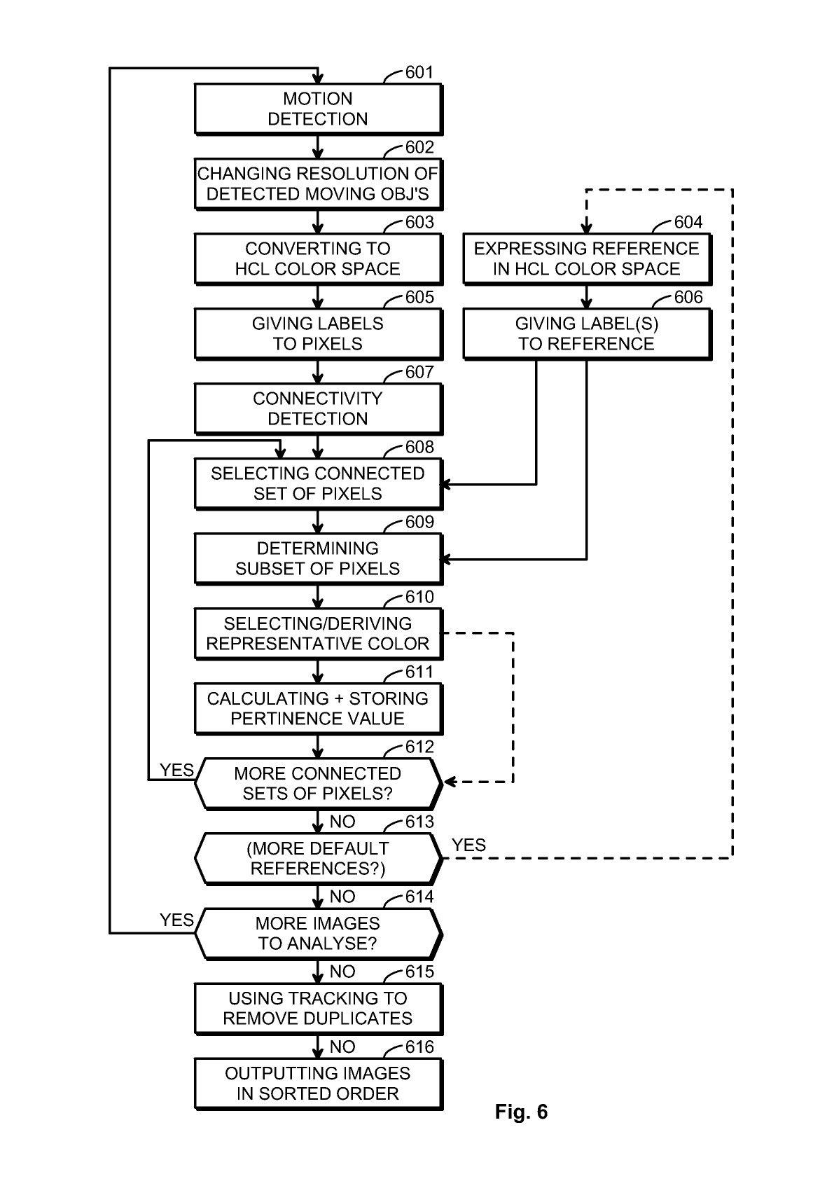

FIG. 6 illustrates details of a method according to an embodiment of the invention. It can also be considered as the illustration of a computer program product according to an embodiment of the invention. The computer program product comprises machine-readable instructions that, when executed by a processor, cause the implementation of the corresponding method steps. The computer program may be embodied on a volatile or a non-volatile computerreadable record medium, for example as a computer program product comprising at least one computer readable non-transitory medium having program code stored thereon.

If motion detection is a part of the method, it can be executed for example at the step illustrated as 601. As was described earlier, motion detection is a way of limiting the consideration into areas of an image where objects or parts of objects appear to be moving in relation to a fixed background, or moving in a significantly different way than anything else within the field of view. It should be noted that the field of view of a camera does not need to be constant in order to enable using motion detection, if the way and rate at which the field of view changes are known. For example if a video camera is panning horizontally with a constant angular speed, we know that stationary objects appear in consecutive frames as if they were moving horizontally with a velocity that depends on their distance from the camera. Image processing methods exist that can be used to compensate for such known movement, so that the motion detection if executed at step 601 will consequently reveal only objects or parts of objects that were not stationary.

Previously it was pointed out that in order to make the evaluations of color similarity compare favourably with the way in which the human brain understands the similarity of colors, it is advantageous to consider the color content of digital image material in a perceptual color space. Therefore in FIG. 6 the step illustrated as 603 comprises converting pixel values into a perceptual color space. The HCL space is given as an example, but it does not limit the applicability of the invention to also other perceptual color spaces. It would be possible to convert the whole piece of digital image material, i.e. the whole image or the whole sequence, into a perceptual color space. However, converting is calculationally intensive, so significant savings can be achieved in required processing capacity, if only those pixels of the digital image material are converted, the conversion of which involves advantages with respect to the continuation of the method.

Consequently step 603 in the method of FIG. 6 may involve converting only those pixels into the perceptual color space that appear on areas where the motion detection of step 601 revealed moving objects or parts of moving objects. Further savings in required processing capacity can be achieved by using a different (coarser) resolution to implement the conversion. For this reason, the exemplary method of FIG. 6 involves step 602, in which the pixel resolution is changed among pixels that were identified through said use of motion detection. Thus in this case the converting of pixel values into the perceptual color space is applied to pixels of the changed pixel resolution. Steps 601, 602, and 603 can be executed in different combinations, for example so that even motion detection can be made on a coarser resolution (inverting the illustrated order of steps 601 and 602), and when an area including movement is found, resolution on that area is again increased before conversion.

Step 604 comprises expressing a color of the reference as a reference record in the same perceptual color space into which the appropriate pixels of the piece of image material were converted in step 603. Later we will consider separately three cases: using principal colors of the perceptual color space as default references, or using a dedicated color of the perceptual color as an actual reference, or defining a default reference as the requirement for maximising or minimising a component value in a color space.

The step illustrated as 605 comprises giving labels to pixels according to how (i.e. to which extent) their converted pixel values belong to environments of principal colors in the perceptual color space. The six principal colors are red, yellow, green, cyan, blue, and magenta. Additionally black, grey, and white may be considered as principal colors; shades of gray appear in the color space on a line that runs directly between black and white (for example: the vertical axis of the HCL color space), so any shade or any number of shades of grey can be selected as “principal” colors according to need simply by selecting points that are located on said line.

Labelling the pixels means a relatively coarse classification, in which each pixel is classified according to what is the principal color the pixel is closest to. It is recommendable to allow the borders of the classes to partially overlap, so that for example a pixel the converted value of which is nearly equally far from saturated red and saturated magenta may receive both the “red” and “magenta” labels. If that pixel additionally has high luminance and low chroma, it may even receive a third label “white”. The labelling does not need to comprise any complicated calculations of color similarity distances, because it may take place simply by comparing the H, C, and L values (or other kinds of color coordinate values, if some other color space than HCL is used) of the pixels to be labeled against some fixed criterion values. Also the reference is given similar labels at step 606. Naturally if a principal color is used as a default reference, giving a label to the reference is particularly straightforward, because the label is always the same as the principal color itself.

The step illustrated as 607 comprises executing connectivity detection among pixels that have at least one common label, in order to identify connected sets of similarly labeled pixels. Of the identified connected sets of pixels, one is selected at the step illustrated as 608. Selecting connected sets may comprise additional filtering, for example so that only such connected sets are selected that have at least a predefined minimum number of pixels. If the reference was also labeled as is illustrated by step 606, it is advantageous to limit the selecting to connected sets where the pixels have one or more labels in common with the reference; other kinds of connected sets would not be close in color to the reference anyway.

Previously we have touched upon a number of possible other filtering strategies, like requiring the represented object or part of object to have a particular shape or spatial relationship to another object or part of object, or requiring the observed movement of the object or part of object to follow a particular direction or trajectory. Concerning size, it should be noted that objects and parts of objects appear in an image differently sized depending on how far they were from the camera in real life. On the other hand, at least in some cases it is possible to make deductions about the distance, based on e.g. where within the field of view the object or part of object appears and how does it move in relation to the horizon. It is possible to make step 608 obey sophisticated selection criteria depending on size, so that real-life objects or parts of objects of at least roughly particular size are focused upon, regardless of how far they originally appeared from the camera.

The step illustrated as 609 comprises determining a subset of a selected connected set of pixels, for proceeding towards determining the representative color. As was described earlier, the subset comprises at least one pixel, and the pixel or pixels of the subset are those for which a color similarity distance to the reference record is at an extremity among the connected set of pixels. The step illustrated as 610 comprises, for a connected set of pixels, storing a representative color that is selected among or derived from the color or colors of the pixels that belong to said connected set.

The step illustrated as 611 becomes actual when matches to a given reference are evaluated. It comprises calculating and storing a pertinence value that is representative of a color similarity distance between the representative color and the reference record. Thus the steps illustrated as 609 to 611 are those in which it is decided and recorded, how accurately does the (representative) color of the selected connected set of pixels match the given reference. If step 611 involves calculating a weighted average of colors, the limitations concerning the size of the subset can be lifted, and the weighted average calculation may use even all pixels of the connected set of pixels as a basis. If multiple sets of connected pixels were found in the same piece of digital image material, step 611 may comprise e.g. only maintaining the value indicating highest pertinence so far, or calculating and storing a refined pertinence value as a function of the individual pertinence values.

The dashed line from step 610 to step 612 is a reminder of the fact that when the method is used as a preparatory processing measure (for example so that the actual reference color is not yet known, and principal colors of the color space and/or the requirement of maximising a component value are used as default references), pertinence values need not be calculated and stored at all. As an illustrative example, we may consider that the principal color “red” was given as the reference at step 604. In that case connectivity detection was performed at step 607 and a connected set of pixels selected at step 608 for pixels for which at least the label “red” has been given at step 605. Then, at step 609, a subset containing the “most red” ones of the connected pixels was determined at step 609. From the colors of the pixels of that subset it was selected or derived at step 610, “how red” the whole connected set of pixels could be characterised to be. The representative color that answered the question “how red?” was stored at step 610 in a connected set database, along with sufficient identification information that enables later re-identifying the frame and connected set in question.

Using the requirement of maximising or minimising a component value in determining the subset of pixels may make the method particularly effective, because it may allow avoiding all calculations of color similarity distances at this phase. As a common description, we may describe such maximising or minimising so that the pixel or pixels of the subset are those for which a color component value that constitutes a part of the converted pixel value is at or close to an extremity among the connected set of pixels.

As an example, we may consider maximising the C (chroma) component value. After selecting a connected set of pixels at step 608, determining a subset at step 609 may be performed by selecting that or those of the pixels in the connected set that have the largest C component value(s). This is an example of the use of an “inverse reference” that was mentioned earlier; the vertical axis at the middle of the color space may be designated as the (inverse) reference, which drives the selection of the subset to those of the connected set of pixels that are as far from the vertical axis as possible.

Going as far as possible from the vertical axis (which is synonymous to maximising the C component value) in the HCL color space means going towards the deepest possible occurrences and/or mixes of pure red, yellow, green, cyan, blue, and magenta that can be found in the connected set of pixels. As a comparison to the description of the other alternative above, the subset containing the “most deeply colored” ones of the connected pixels was now determined at step 609. From the colors of the pixels of that subset it was selected or derived at step 610, “how deeply colored” the whole connected set of pixels could be characterised to be, and in which direction (H component value). The representative color that answered the question “how deeply colored and in which direction?” was stored at step 610 in a connected set database, along with sufficient identification information that enables later re-identifying the frame and connected set in question.

The step illustrated as 612 comprises a check, whether the current piece of digital image material has more connected sets of pixels to be analysed; a positive finding leads to selecting a new connected set of pixels at step 608.

Again assuming that the method is used as a preparatory processing measure, so that representative colors with respect to more than one default reference should be found, there may be a step 613 for checking, whether all appropriate default references have been considered already. If there are more, a return to step 604 occurs for selecting another default reference. It is also possible to designate more than one reference when step 604 is first executed, so that subsequently when a particular connected set is considered at steps 607 to 610, its representative colors with respect to two or more default references will be found and stored in parallel.

The step illustrated as 613 comprises a check, whether there are more pieces of digital image material to be analysed, with a positive finding leading to beginning the process anew with a new piece of digital image material at step 601.

A sequence of digital images may comprise the same object appearing in a number of individual images. A tracking algorithm is capable of identifying the appearance of the same object from a number of digital images, so movements of the object within the field of view can be followed. In some cases it is desirable that concerning a particular object, only the most pertinent image is output even if the appearance of that particular object would meet the reference fairly well also in other images of the sequence. Therefore FIG. 6 illustrates a step 614 where it is possible to use tracking to reject duplicate appearances of the same object.

The step illustrated as 615 comprises outputting the results or otherwise providing an indication that the evaluation is complete. For example, assuming that the method was used for the evaluation of pertinence of individual images, step 615 may comprise displaying an output screen in which thumbnail icons of the evaluated images appear in an order of pertinence.

### Utilising Preprocessed Digital Image Material

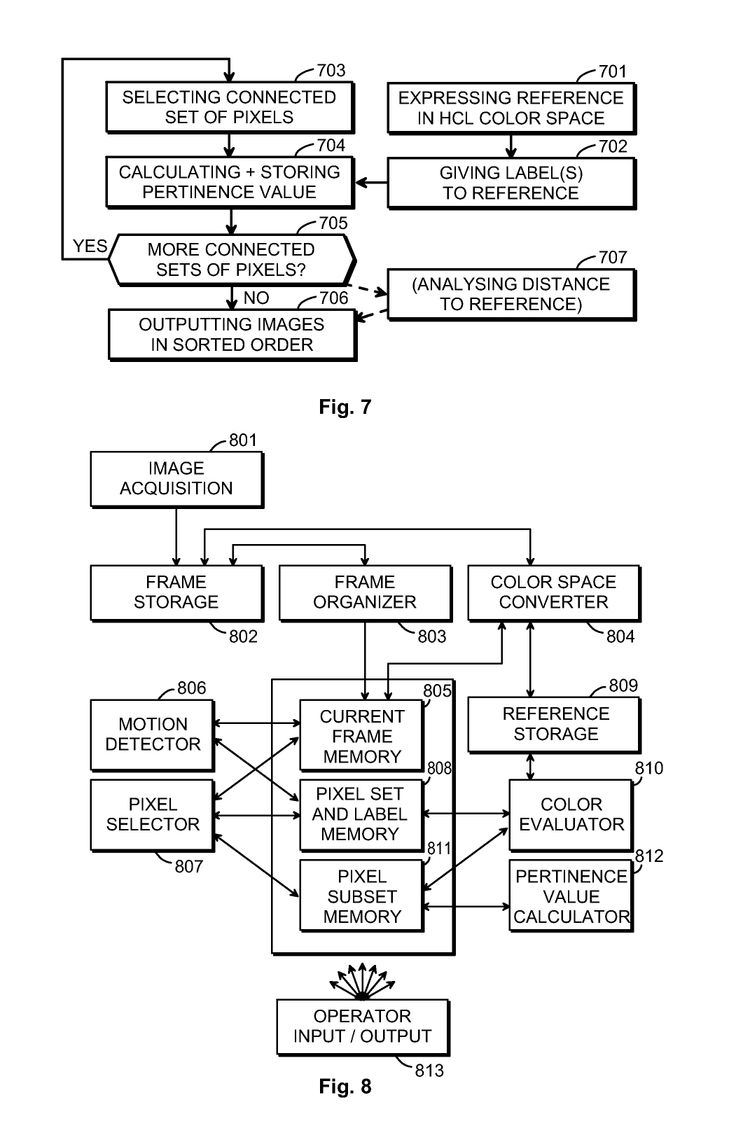

In FIG. 7 we assume that digital image material has been previously preprocessed. The result of the preprocessing is a database of connected sets, where metadata identifies a number of connected sets of pixels that have been detected. For each connected set of pixels, the metadata reveals sufficient identification information (for example: in which frame of which video sequence the connected set of pixels can be found), as well as at least one representative color. If several default references (like all principal colors of a color space) were used in preprocessing, at least some of the connected sets may be revealed to have at least two representative colors, one in respect of each default reference. For example, a connected set of pixels that in a perceptual color space was located at or close to the borderline between red and yellow may have two representative colors, one of which tells “how red” the connected set of pixels is while the other tells “how yellow” the same connected set of pixels is. In FIG. 7 we also assume that a “true” reference is now given. The true reference may be any arbitrary reference, the color of which can be expressed as a reference record in a perceptual color space at step 701. The step illustrated as 702 comprises giving at least one label to the reference record. Similarly as in FIG. 6, the labelling at step 702 is made according to how (i.e. to which extent) the converted color(s) of the reference belong to environments of principal colors in the perceptual color space.

The loop comprising steps 703, 704, and 705 involves making a search in the connected set database in order to identify connected sets of pixels that would match the reference as closely as possible. The step illustrated as 703 comprises selecting a connected set of pixels from the database, and step 704 comprises calculating and storing a pertinence value in the same way as was described earlier with reference to step 611 in FIG. 6. If the connected set database comprises indications about the labels that have previously been given to the pixels of the connected sets, screening by label can be applied in the selection step 703 so that only such connected sets are selected that have at least one common label with the reference. The checking at step 705 is only illustrated in order to show that a thorough search of the database should be made in order to be certain to find the closest possible match to the given reference. Outputting the results at step 706 can take place for example in the same way as was explained above with reference to step 616 of FIG. 6.

Calculating the pertinence values at step 704 is now significantly faster than if one should, after being given the true reference, start from scratch by identifying connected sets of pixels, comparing their colors to the true reference, and so on. Due to the preprocessing, the connected set database already contains—not only identifiers of connected sets but also—a representative color (or a relatively small number of representative colors) of each connected set. Thus if the pertinence value is a color similarity distance in the perceptual color space or some derivative therefrom, the distance calculation only needs to be done once or at most a relatively small number of times per each connected set. Additionally the labels help to avoid considering connected sets that would be hopelessly far from the reference anyway: as long as there are connected sets the pixels of which have at least one label in common with the reference, it is not necessary to consider other connected sets at all, because their distance to the reference will inevitably be longer.

It should be noted that using a representative color that was previously selected with respect to a default reference or by maximising a component value will not always give the shortest color similarity distance between the true reference and the colors of all pixels included in the connected component. As an example, we may consider a connected set, the pixels of which are predominantly red. In the perceptual color space, the colors found among the pixels of the connected set could occupy for example a roughly spherical volume that is located relatively close to the point that represents pure red. Selecting a representative color with respect to the default reference “red” during preprocessing emphasizes those points of said spherical volume that are closest to the point of pure red, so the representative color of that connected set will be located within a spherical cap on that side of said spherical volume that faces the point of pure red. Similarly, selecting a representative color by maximising (minimising) the C component value emphasizes those points of the spherical volume that are farthest away from (closest to) the vertical axis in the HCL color space, so the representative color of that connected set will be located at that side of the spherical volume that faces directly outwards (inwards) in the HCL color space.

Let us then assume that the true reference is expressed as a reference record that is a point midway between two principal colors, say red and yellow, in the perceptual color space. The true reference will be given the labels “red” and “yellow”, so the connected set mentioned above will be selected at step 703 of FIG. 4. The shortest color similarity distance, however, between the true reference and the spherical volume enclosing the colors found in said connected set is now measured along a line that intersects the spherical volume on that side of it that faces the reference record. The color similarity distance between the reference record and the previously selected representative color is longer.

Several measures can be taken in order to avoid any potential inaccuracy that could follow from the phenomenon explained above. One could define more “principal” colors for preprocessing, so that the perceptual color space will be covered with a denser network of default references—however, at the cost of more complicated labelling and the consequently higher demand of resources. Another possibility is illustrated schematically as step 707 in FIG. 7. After the loop of steps 703, 704, and 705 has been completed sufficiently many times so that all appropriate connected sets (i.e. those that are at least relatively close to the reference, judging by their previously selected representative color) have been identified, one may perform a more detailed analysis that involves calculating the shortest distance between each identified connected set and the true reference. Even if such calculating involves additional calculations of color similarity distances (i.e. finding a new representative color for each identified connected set, this time among those of its pixels that are closest in color to the true reference instead of being closest to some default reference that was used in preprocessing), those calculations only need to be performed for a relatively limited number of connected sets, instead of all connected sets that can be found in what can be hours or days of video footage.

### Exemplary Embodiment of an Arrangement

FIG. 8 illustrates schematically an arrangement according to an embodiment of the invention. Illustrated as 801 is an image acquisition subsystem, which is configured to supply digital image material. The image acquisition subsystem 801 may comprise e.g. one or more digital cameras, like digital video cameras and/or digital still image cameras. Illustrated as 802 and 803 are a frame storage and a frame organizer respectively; these are configured to maintain digital image material in memory as frames and to read, write, and arrange the stored frames according to need. In order to prepare for the case that acquired digital image material is not readily represented in a perceptual color space, there is provided a color space converter 804 that is configured to apply the necessary conversion formulae for converting digital image material between different color spaces. Such conversions can be made for image information at various stages, so the connections shown for the color space converter 804 are only indicative.

The frame organizer 803 is configured to provide a piece of digital image material in a current frame memory 805, which may be a physically different memory location or just a logically identified part of the frame storage 802. A motion detector 806 is configured to perform motion detection within a sequence of digital images in order to identify areas of images that represent objects or parts of objects that appear non-stationary in corresponding sequences of digital images. A pixel selector 807 is configured to select from a piece of digital image material connected sets of pixels that represent objects. FIG. 8 shows a separate pixel set and label memory 808 for storing selected connected sets of pixels and their labels, but again this is only a graphical illustration and the corresponding functionality may exist on only the logical level. If labelling of pixels according to principal colors or other default references are used, that may also be implemented in the part of the arrangement illustrated as the pixel selector 807.

A reference storage 809 is configured to store a color of a reference as a reference record in the perceptual color space. A color evaluator 810 is configured to determine, possibly in cooperation with the pixel selector 807, subsets of individual ones of the connected sets of pixels. A subset comprises at least one pixel, and the pixel or pixels of the subset are those for which a color similarity distance to said reference record is at an extremity among a connected set of pixels. In order to evaluate color similarity distances, the color evaluator 810 comprises a color similarity distance calculator (not separately shown) that is configured to consult the reference storage 809 for the location of the reference record in the perceptual color space. Again more as a graphical illustration of a logical level arrangement rather than as any requirement of the existence of a physically different part, FIG. 8 illustrates a pixel subset memory 811 that is configured to store information about the subsets. One of the pixel set and label memory or pixel subset memory 811 may also act as a representative color storage that is configured to store, for connected sets of pixels, one or more characteristic colors that are selected among or derived from the color or colors of the pixels that belong to the subset in question. Thus the connected set database mentioned earlier may be implemented using one or both of these storage units.

A pertinence value calculator 812 is configured to calculate and store, for pieces of digital image material, corresponding pertinence values that are representative of a color similarity distance between a subset and the reference record. The pertinence value calculator 812 may have a connection with the frame organizer 803, so that frames or other pieces of digital image material can be arranged in order of pertinence in respect of matching the reference. Results of the arranging can be displayed through the operator input and output part of the arrangement, which is schematically shown as 813 in FIG. 8.

### Further Considerations

The embodiments illustrated above are only examples of the applicability of the invention and they do not limit the scope of protection of the enclosed claims. For example, other imaging devices than cameras may be used for image acquisition, and in many cases the mutual order of executing the method steps may be changed.

The invention may also be applied in evaluating the pertinence of digital image material in respect of matching two or more different colors. Thus, instead of only providing one reference record, one may provide two or more reference records that come from different parts of the perceptual color space. The pertinence values should then reflect the color similarity differences of identified connected sets of objects to all applicable references. For example, the highest pertinence may be given to the image that has the overall smallest color similarity difference to any individual reference, regardless of how well it matches the other reference(s). As an alternative, one may calculate the pertinence value as the mean value of the smallest color similarity differences to all individual references, in which case those images would be the most pertinent in which at least an approximate match is found with all applicable references.

Size, spatial location, and other descriptors of identified connected sets of pixels have been mentioned earlier as criteria for selecting or not selecting them, but in addition or alternatively they may be used as additional ordering criteria at the output stage. For example, one may display separately all those video clips where an object matching the reference color appeared as moving from left to right, as opposed to those where it was moving from right to left.

1-19. (canceled)

20. A method for analysing the pertinence of digital image material in respect of matching a given reference object appearing in the digital image material, comprising:
expressing a color of said reference object as a reference record in a perceptual color space,
converting pixel values of a piece of digital image material into said perceptual color space,
giving labels to pixels of said piece of digital image material according to how their converted pixel values belong to environments of principal colors in said perceptual color space,
selecting a connected set of pixels that have at least one common label and that according to connectivity analysis belong to a connected component, and
determining a subset of said connected set of pixels, so that the pixel or pixels of said subset are those for which a color similarity distance to said reference record is at an extremity among said connected set of pixels, and
for said connected set of pixels, storing a representative color that is selected among or derived from the color or colors of the pixels that belong to said subset.

21. A method according to claim 20, comprising:
giving one or more labels to said reference according to how its value or values in said perceptual color space belong environments of principal colors in said perceptual color space, and
only selecting such a connected set of pixels where the pixels have one or more labels in common with the reference.

22. A method according to claim 20, comprising:
expressing a color of a first reference as a first reference record in said perceptual color space,
determining said subset of said connected set of pixels so that the pixel or pixels of said subset are those for which a color similarity distance to said default reference record is at an extremity among said connected set of pixels,
expressing a color of a second reference as a second reference record in said perceptual color space, and
for said piece of digital image material, calculating and storing a pertinence value that is representative of a color similarity distance between said representative color and said second reference record, wherein said color similarity distance is the distance between said representative color and said second reference record in said perceptual color space.

23. A method according to claim 22, wherein said piece of digital image material comprises a sequence of digital images, and the method additionally comprises at least one of the following:
calculating and storing pertinence values separately for a number of individual digital images of said sequence, and calculating and storing a pertinence value for the sequence as a function of the pertinence values of the individual digital images;
expressing limits for targeted appearance of objects or parts of objects in images of a sequence, and only selecting a connected set of pixels as a response to finding that an object or part of object represented by such pixels makes an appearance that is within said limits in the sequence under examination.

24. A method according to claim 23, wherein said limits for targeted appearance comprise at least one of the following:
a target direction in which an object or part of object appears to move in images of said sequence
a target trajectory along which an object or part of object appears to move in images of said sequence.

25. A method according to claim 20, wherein:
said piece of digital image material consists of a single digital image extracted from a sequence of digital images, and
the method comprises using motion detection within said sequence of digital images in selecting said connected set of pixels, so that they represent an object or part of object that appears non-stationary in said sequence of digital images.

26. A method according to claim 25, comprising:
for each digital image in said sequence, calculating and storing a pertinence value that is representative of a color similarity distance between said representative color and a reference record, wherein said color similarity distance is the distance between said representative color and the reference record in said perceptual color space, and
putting a number of digital images in said sequence in order according to the order of magnitude of their pertinence value, thus indicating an order of pertinence in which images of said sequence match said reference.

27. A method according to claim 20, wherein a connected set of pixels is only selected as a response to finding that involves at least one of the following:
the object or part of object represented by said connected set of pixels appears to have a size that fits predefined limits,
the object or part of object represented by said connected set of pixels appears to have a shape that meets a predefined reference shape at a predefined accuracy,
the object or part of object represented by said connected set of pixels appears to have a predefined spatial relation to another object or part of object.

28. A method according to claim 20, wherein said reference record is one of the following: a point in said perceptual color space, a subspace that encloses a number of points in said perceptual color space.

29. A method according to claim 20, wherein said perceptual color space is a HCL space such that the C and L values of a pixel are related to R, G, and B values of said pixel through
$${D}_{HCL} = \sqrt{{[ {A}_{L} ( {L}_{1} - {L}_{2} ) ]}^{2} + {A}_{H} [ {C}_{1}^{2} + {C}_{2}^{2} - 2 {C}_{1} {C}_{2} cos ( {H}_{1} - {H}_{2} ) ]}$$
Y₀, Y₁, Y₂, and γ are constants;
and the H value of a pixel is related to R, G, and B values of said pixel through one of
$$L = \frac{Q \cdot {max}_{} ( R , G , B ) + ( 1 - Q ) \cdot {min}_{} ( R , G , B )}{{Y}_{1}}$$
$$C = \frac{Q \cdot ( \vert R - G \vert + \vert G - B \vert + \vert B - R \vert )}{{Y}_{2}}$$
$$where Q = {e}^{αγ} , \\ α = \frac{{min}_{} ( R , G , B )}{{max}_{} ( R , G , B )} \cdot \frac{1}{{Y}_{0}} ,$$
and where said color similarity distance between two HCL value sets H₁C₁L₁ and H₂C₂L₂ is calculated as
$${D}_{HCL} = \sqrt{{[ {A}_{L} ( {L}_{1} - {L}_{2} ) ]}^{2} + {A}_{H} [ {C}_{1}^{2} + {C}_{2}^{2} - 2 {C}_{1} {C}_{2} cos ( {H}_{1} - {H}_{2} ) ]}$$
where A_{L} and A_{H} are constants.

30. A method according to claim 29, wherein:
Y₀=100,
Y₁=2,
Y₂=3,
γ=3,
A_{L}=1.4456, and
A_{H}=1.

31. A method according to claim 20, wherein:
the method comprises using motion detection to identify pixels that represent an object or part of object that appears non-stationary in a sequence of digital images, and
said converting of pixel values into said perceptual color space is applied only to pixels that were identified through said use of motion detection.

32. A method according to claim 31, comprising:
after said use of motion detection to identify pixels, changing the pixel resolution among pixels that were identified through said use of motion detection, so that said converting of pixel values into said perceptual color space is applied to pixels of the changed pixel resolution.

33. A method according to claim 20, wherein said determining of a subset of said connected set of pixels is made so that the pixel or pixels of said subset are those for which a color component value that constitutes a part of the converted pixel value is at or close to an extremity among said connected set of pixels.

34. A method according to claim 20, wherein said giving labels comprises labelling a pixel according to the principal color that is closest to the pixel in said perceptual color space

35. An arrangement for analysing the pertinence of digital image material in respect of matching a given reference object appearing in the digital image material, comprising:
a reference storage configured to store a color of said reference object as a reference record in a perceptual color space,
a pixel selector configured to select from a piece of digital image material connected sets of pixels,
a color evaluator configured to determine subsets of individual ones of said connected sets of pixels, a subset comprising at least one pixel, so that the pixel or pixels of said subset are those for which a color similarity distance to said reference record is at an extremity among said connected set of pixels, and
a representative color storage configured to store, for said connected set of pixels, a representative color that is selected among or derived from the color or colors of the pixels that belong to said subset.

36. An arrangement for analysing the pertinence of digital image material in respect of matching a given reference object appearing in the digital image material, comprising:
a reference storage configured to store a color of said reference object as a reference record in a perceptual color space,
a pixel value converter configured to convert pixel values of a piece of digital image material into said perceptual color space,
a color evaluator and labelling unit configured to give labels to pixels according to how their converted pixel values belong to environments of principal colors in said perceptual color space,
a pixel selector configured to select from a piece of digital image material connected sets of pixels that have at least one common label and that according to connectivity analysis belong to a connected component, and to determine subsets of said connected sets of pixels so that the pixel or pixels of subsets are those for which a color similarity distance to said reference record is at an extremity among the respective connected set of pixels, and
a representative color storage configured to store, for said connected set of pixels, a representative color that is selected among or derived from the color or colors of the pixels that belong to said subset.

37. An arrangement according to claim 36, comprising:
a pertinence value calculator configured to calculate and store, for pieces of digital image material, corresponding pertinence values that are representative of a color similarity distance between said reference record and a subset selected from the respective piece of digital image material.

38. An arrangement according to claim 36, comprising:
a motion detector configured to perform motion detection within a sequence of digital images in selecting said connected set of pixels, so that they represent an object or part of object that appears non-stationary in corresponding sequences of digital images.

39. An arrangement according to claim 36, comprising an image acquisition subsystem configured to supply said digital image material.

40. An arrangement according to claim 36, wherein said color evaluator and labelling unit is configured to label a pixel according to the principal color that is closest to the pixel in said perceptual color space.

41. A computer program product, comprising machine-readable instructions that, when executed in a processor, are configured to cause the execution of a method comprising:
expressing a color of a reference object appearing in the digital image material as a reference record in a perceptual color space,
converting pixel values of a piece of digital image material into said perceptual color space,
giving labels to pixels of said piece of digital image material according to how their converted pixel values belong to environments of principal colors in said perceptual color space,
selecting a connected set of pixels that have at least one common label and that according to connectivity analysis belong to a connected component, and
determining a subset of said connected set of pixels, so that the pixel or pixels of said subset are those for which a color similarity distance to said reference record is at an extremity among said connected set of pixels, and
for said connected set of pixels, storing a representative color that is selected among or derived from the color or colors of the pixels that belong to said subset.
